(19) United States
(12) Patent Application Publication
(10) Pub. No.: US 2014/0331962 A1
(43) Pub. Date: Nov. 13, 2014

(54) Dual Fuel Engine System And Engine System Operating Method

(71) Applicant: CATERPILLAR, INC., Peoria, IL (US)

(72) Inventor: Alan Stockner, Metamora, IL (US)

(73) Assignee: Caterpillar, Inc., Peoria, IL (US)

(21) Appl. No.: 13/889,271

(22) Filed: May 7, 2013

(51) Int. Cl. F02D 41/00

(52) U.S. Cl. CPC F02D 41/0025
USPC 123/304

(57) ABSTRACT

Operating a dual gaseous and liquid fuel engine includes injecting gaseous and liquid fuels directly into an engine cylinder, and compression igniting the liquid fuel to ignite the gaseous fuel therein. Data indicative of energy content of injected gaseous fuel and also energy content of gaseous fuel conveyed to compensate for depletion of gaseous fuel via injection is received, and a signal outputted indicative of an energy imbalance between the injected and conveyed gaseous fuel responsive to the data. Diagnostics are run in response to the signal.

### TECHNICAL FIELD

The present disclosure relates generally to dual gaseous and liquid fuel engine systems, and more particularly to detecting an energy imbalance in a gaseous fuel side of the system.

### BACKGROUND

One relatively new class of engines seeks to utilize two different fuels to gain efficiencies associated with compression ignition combined with advantages associated with burning gaseous fuel such as natural gas. In particular, one type of dual fuel engine utilizes a small pilot injection quantity of liquid diesel fuel that is compression ignited to in turn ignite a much larger charge of natural gas fuel in each engine cylinder. In one strategy for this type of engine, both fuels are directly injected from a single fuel injector associated with each engine cylinder.

As gaseous fuel technology has developed, both for dual fuel applications and gaseous fuel only applications, complexity of the overall engine and fuel system has increased. While increasing complexity and sophistication in gaseous fuel systems and sub-systems has enabled gaseous fuel engines to come closer to their full theoretical potential respecting efficiency and emissions, these advances have been accompanied by greater challenges with regard to monitoring, detecting, isolating and diagnosing various operational problems with such systems. U.S. Pat. No. 7,913,496 to Batenburg et al. proposes an apparatus and method for pumping a cryogenic fluid from a storage vessel, and determining via measurement of various parameters when cryogenic pump performance is degraded. An operator of the apparatus is apparently notified when pump performance has degraded below a predetermined threshold volumetric efficiency. While Batenburg et al. may be applicable within its intended service environment, there is ample room for improvement and new and expanded applications of performance monitoring techniques relating to gaseous fuel systems.

### SUMMARY

In one aspect, a method of operating a dual gaseous and liquid fuel engine system includes injecting gaseous fuel and liquid fuel directly into an engine cylinder via a gaseous fuel outlet set and a liquid fuel outlet set, respectively, of at least one fuel injector in the engine system. The method further includes compression igniting the injected liquid fuel to ignite the injected gaseous fuel, and conveying gaseous fuel through a gaseous fuel subsystem in the engine system to compensate for depletion of gaseous fuel via the injection thereof. The method further includes receiving data indicative of an energy content of the injected gaseous fuel, receiving data indicative of an energy content of the conveyed gaseous fuel, and outputting a signal indicative of an energy imbalance between the injected gaseous fuel and the conveyed gaseous fuel responsive to the data indicative of the respective energy contents.

In another aspect, a dual gaseous and liquid fuel engine system includes an internal combustion engine having a plurality of cylinders formed in an engine housing, and a gaseous fuel subsystem including a gaseous fuel common rail, and gaseous fuel supply and pressure control mechanisms configured to convey a gaseous fuel through the gaseous fuel subsystem to supply the gaseous fuel common rail. The engine system further includes a liquid fuel subsystem including a liquid fuel common rail, and liquid fuel supply and pressure control mechanisms configured to convey a liquid fuel through the liquid fuel subsystem to supply the liquid fuel common rail. The engine system further includes a plurality of fuel injectors each having a fuel injector body positioned at least partially within one of the plurality of cylinders and having formed therein a gaseous fuel outlet set in fluid communication with the gaseous fuel common rail, for injecting a gaseous fuel into the one of the plurality of cylinders, and a liquid fuel outlet set in fluid communication with the liquid fuel common rail, for injecting a liquid fuel into the one of the plurality of cylinders. The engine system further includes a control system having an electronic control unit configured to receive data indicative of an energy content of injected gaseous fuel and data indicative of an energy content of gaseous fuel conveyed through the gaseous fuel subsystem to compensate for depletion of gaseous fuel via injection thereof. The electronic control unit is further configured to output a signal indicative of an energy imbalance between the injected gaseous fuel and the conveyed gaseous fuel, responsive to the data indicative of the respective energy contents.

In still another aspect, a method of detecting adverse system health in a dual gaseous and liquid fuel engine system includes receiving data indicative of an energy content of gaseous fuel injected via a fuel injector into a cylinder of an internal combustion engine and ignited therein via compression ignition of liquid fuel injected via the same fuel injector. The method further includes receiving data indicative of an energy content of gaseous fuel conveyed through a gaseous fuel conduit in the engine system to compensate for depletion of gaseous fuel via the injection thereof. The method still further includes logging a fault responsive to an energy imbalance between the injected gaseous fuel and the conveyed gaseous fuel responsive to the data indicative of the respective energy contents.

### BRIEF DESCRIPTION OF THE DRAWINGS

FIG. 1 is a diagrammatic view of a machine equipped with a dual fuel engine system according to the present disclosure;

FIG. 2 is a schematic view of a dual fuel engine system according to the present disclosure;

FIG. 3 is a perspective view of a portion of an engine and dual fuel system similar to that depicted in FIG. 1;

FIG. 4 is a sectioned view, in perspective, of a portion of the engine system shown in FIG. 2 to reveal structure for one fuel injector and engine cylinder;

FIG. 5 is a sectioned front view of a fuel injector according to another aspect of the present disclosure; and

FIG. 6 is a flowchart showing a method of engine system operation according to the present disclosure.

### DETAILED DESCRIPTION

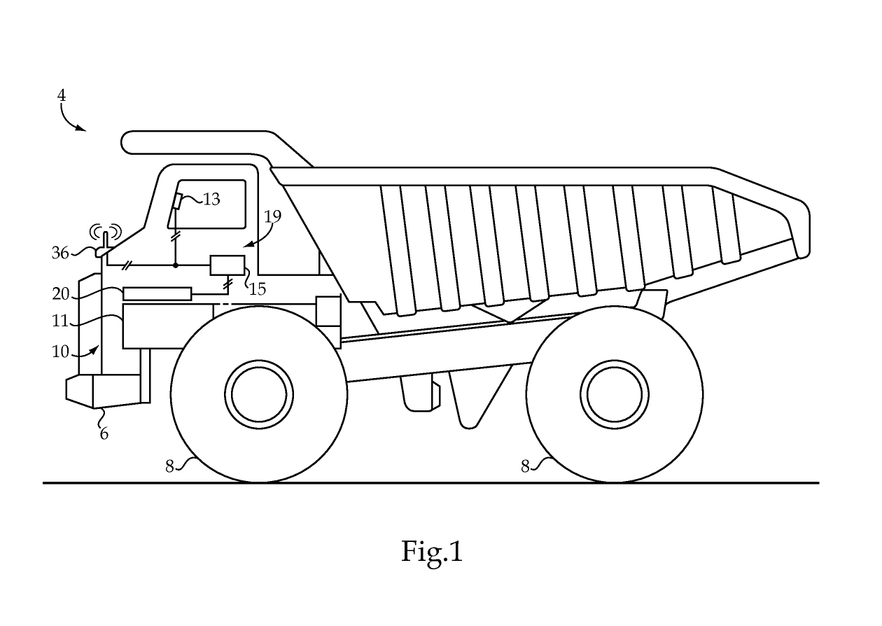

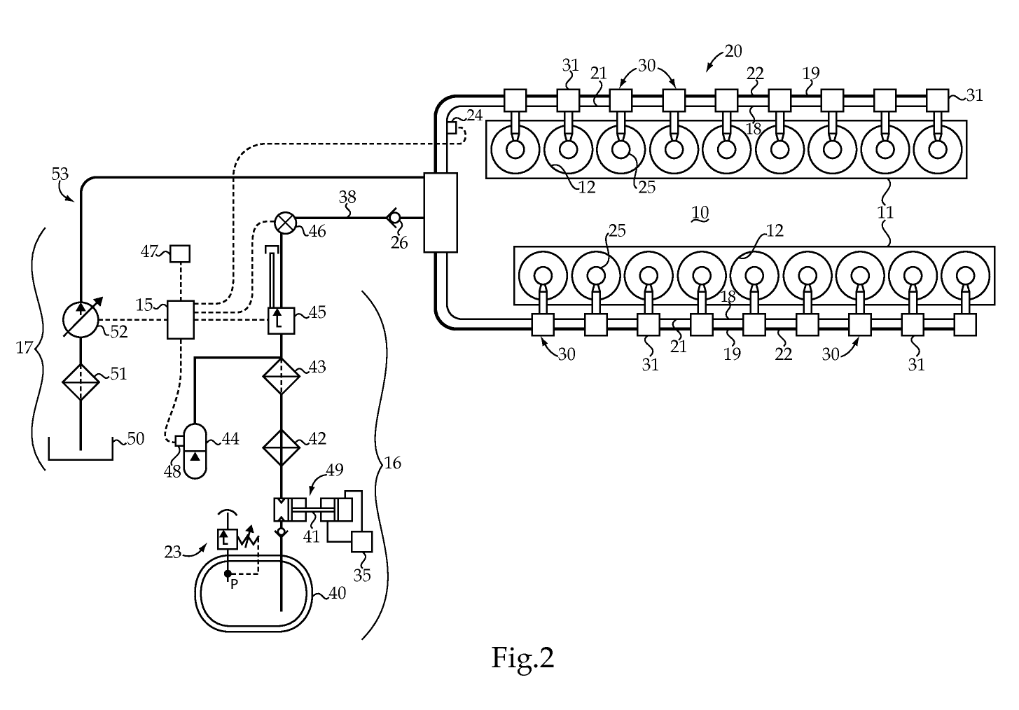

Referring to FIG. 1, there is shown a machine 4 equipped with a dual fuel engine system 10, according to the present disclosure. Machine 4 is shown in the context of an off-highway truck having a frame 6 and ground engaging wheels 8 mounted to frame 6 in a conventional manner. In other embodiments, machine 4 might include a different type of off-highway machine such as a track-type machine, an on-highway machine, or a stationary pump, compressor, or power generation machine such as a genset. Engine system 10 includes an engine housing 11 and a dual gaseous and liquid fuel system 20 coupled with engine housing 11 to provide liquid fuel and gaseous fuel for operation in a manner further discussed herein. Machine 4 is also equipped with an engine control system 9 including an electronic control unit 15. Referring also to FIG. 2, electronic control unit 15 is in control communication with certain components of dual gaseous and liquid fuel system 20, and also in control communication with an operator alert mechanism 13 and a transmitter/receiver 36. Alert mechanism 13 may include an audible alert device and/or an instrument panel graphical or illuminated display, suitable for positioning in an operator cab of machine 4. Transmitter/receiver 36 may include any suitable device such as a conventional antennae for transmitting and/or receiving wireless signals. Electronic control unit 15 is also in communication with a computer readable memory 47 storing engine fueling and diagnostic algorithms in the form of computer executable code, as further discussed herein.

As will be further apparent from the following description, control system 9 may be configured to monitor and control certain aspects of engine system 10 in a manner distinct from earlier strategies. Control system 9 may notify an operator of a status of engine system 10 via operator alert device 13, transmit a signal conveying analogous information via transmitter/receiver 36 to a control station such as a management center at a mine site, and also run certain diagnostics respecting operation and performance of engine system 10. The capability of diagnosing performance and operational problems, and in many instances isolating such problems to certain parts of engine system 10, is considered to advance over prior strategies generally limited to determining merely that problems exist. Moreover, the teachings of the present disclosure may be applied to not only diagnose operational problems and conditions but in many instances provide prognostic analysis of the state of dual fuel system 20 and components thereof. In the case of acute and relatively rapid changes in the state of monitored parameters, control system 9 might act to alert an operator and/or a fleet manager that service is immediately required, and switch operation of engine system 10 to a limp home mode or the like. Where the state of a monitored parameter indicates a relatively more gradual degradation in performance, control system 9 might log a fault, perform a diagnosis, and determine whether maintenance is required prior to a next scheduled service of machine 4. In still other instances, data gathered as to the states of operational parameters and conditions can simply be recorded on memory 47 to populate stored histories of those parameters and conditions. In any case, it will be further understood from the following description that the various forms of monitoring, diagnostic and system operating methodology and control logic contemplated herein exploit principles of detecting and acting upon energy imbalances in fuel system 20 in a manner distinct from conventional practices.

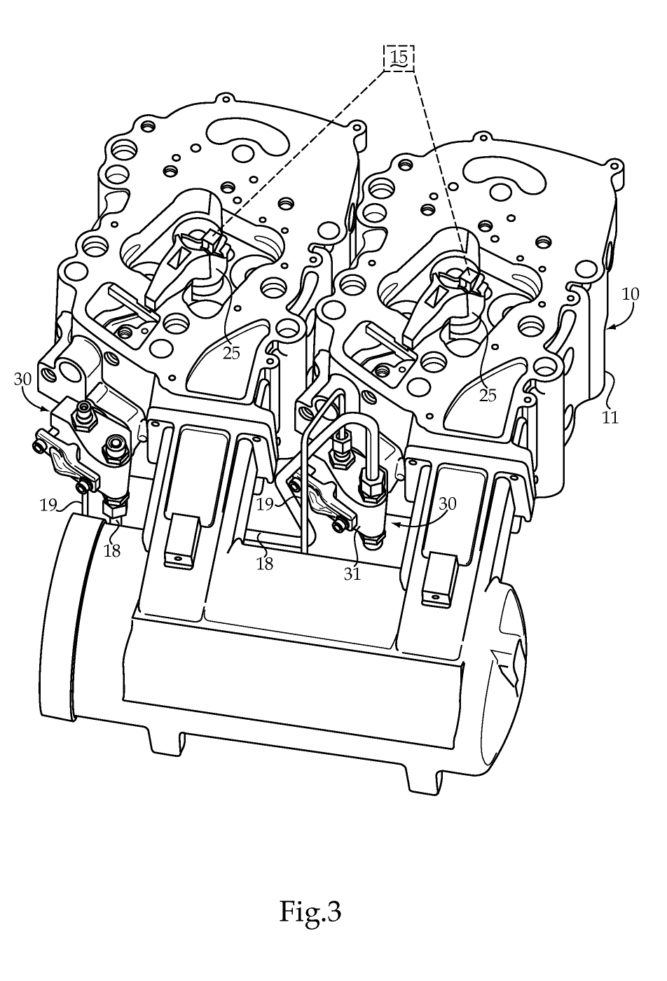

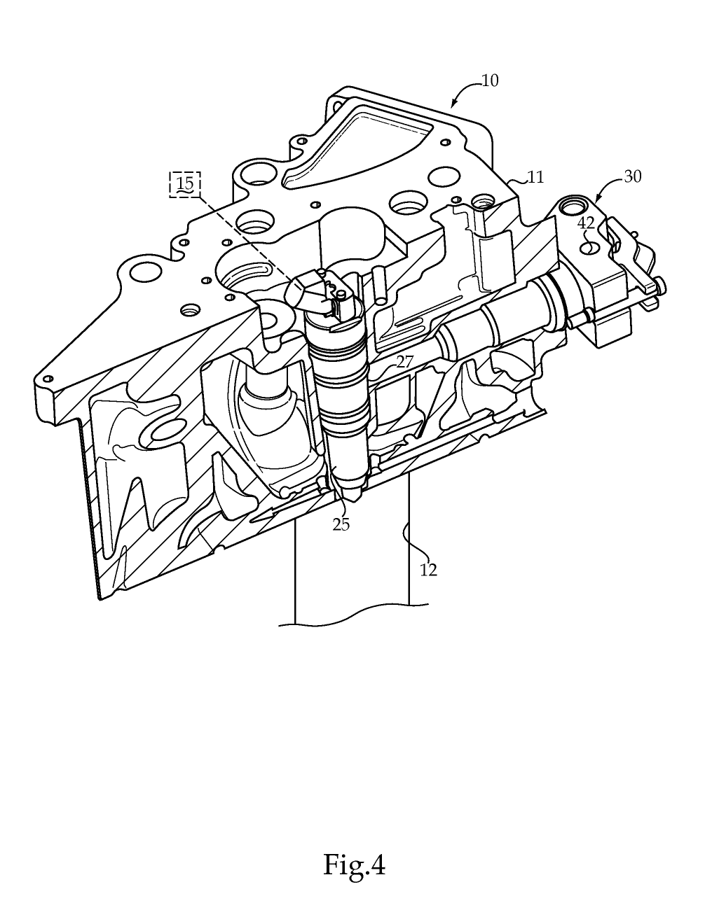

Referring additionally to FIGS. 3 and 4, engine housing 11 has a plurality of engine cylinders 12 formed therein, and dual fuel system 20 may include exactly one fuel injector 25 positioned at least partially within each one of the plurality of engine cylinders 12 for direct injection of fuel therein. A gaseous fuel common rail 21 and a liquid fuel common rail 22 are fluidly connected to each fuel injector 25, and are parts of a gaseous fuel subsystem 23 and a liquid fuel subsystem 53 of dual fuel system 20, respectively. Dual fuel system 20 also includes gaseous fuel supply and pressure control mechanisms 16 configured to convey a gaseous fuel such as natural gas through subsystem 23 to supply common rail 21. Liquid fuel supply and pressure control mechanisms 17 are configured to convey liquid fuel such as diesel through subsystem 53 to supply common rail 22. A gaseous fuel conduit 38 fluidly connects mechanisms 16 to common rail 21, and a check valve 26 is positioned within conduit 38 in the illustrated embodiment. Each of fuel injectors 25, gas supply and pressure control mechanisms 16, and liquid supply and pressure control mechanisms 17 are in control communication with, and controlled by, electronic control unit 15 in a known manner. Gaseous fuel supply and pressure control mechanisms 16 may include a pressurized cryogenic liquefied natural gas supply or tank 40 with an outlet fluidly connected to a variable delivery cryogenic pump 49.

Pump 49 may include a reciprocating pump with one end of a double-headed piston 41 reciprocating to transfer liquefied natural gas in response to induced reciprocation of an opposite end via hydraulic fluid. A hydraulic actuation system 35 of suitable known type supplies hydraulic fluid to, and receives hydraulic fluid from, pump 49 to reciprocate the same. Dual fuel system 20 may also include an electronically controlled isolation or shutoff valve 46 operably positioned between mechanisms 16 and gaseous fuel common rail 21. Valve 46 may be mechanically biased toward a closed position but movable to an open position responsive to a control signal from electronic control unit 15. When dual fuel system 20 is being operated in a regular mode further discussed herein, electronic control unit 15 may maintain valve 46 in an open position. However, in the event that the system transitions into a liquid only mode of operation also further discussed herein, electronic control unit 15 may close valve 46, or allow valve 46 to close, to fluidly isolate mechanisms 16 from any leaked liquid fuel that may find its way into the gaseous side of dual fuel system 20. Mechanisms 16 may also include a heat exchanger or vaporizer 42, an accumulator 44, a gas filter 43, and a fuel conditioning module 45 that controls the supply and pressure of gaseous fuel to gaseous fuel common rail 21. Fuel conditioning module 45 may serve to meter the supply of gaseous fuel to common rail 21, the significance of which will be further apparent from the following description. An accumulator pressure sensor 48 and a rail pressure sensor 24 are each in communication with control unit 15. Mechanisms 16 may supply gaseous fuel to common rail 21 at a medium fuel pressure relative to a supply pressure of liquid fuel.

Liquid supply and pressure control mechanisms 17 may include a diesel fuel supply or tank 50, a fuel filter 51 and an electronically controlled high pressure fuel pump 52 configured to pressurize liquid fuel and convey the liquid fuel through subsystem 53 to supply liquid fuel common rail 22. Mechanisms 17 may supply liquid fuel to common rail 22 at a range of higher fuel pressures relative the medium pressure of gaseous fuel in common rail 21. Each of gaseous fuel pressure and liquid fuel pressure may be adjustable for reasons which will be understood by those skilled in the art, but in general liquid fuel pressures will be higher than gaseous fuel pressures, at least within common rails 21 and 22, in practical implementation strategies.

Dual fuel system 20 may also include a plurality of coaxial quill connectors 30 each with an inner quill defining an inner fuel passage and an outer quill defining an outer fuel passage, and having a tip in sealing contact with a common conical seat of one of fuel injectors 25. Each of a plurality of similar or identical quill connectors 30 may be coupled one with each of fuel injectors 25. Coaxial quill connectors 30 may be daisy-chained together with gaseous fuel line segments 18 and liquid fuel line segments 19 to form gaseous fuel common rail 21 and liquid fuel common rail 22, respectively. The last coaxial quill connector 30 in the daisy-chain may have a set of plugs in place of fittings. A coaxial quill connector 30 is fluidly positioned between each of the plurality of fuel injectors 25 and each of gaseous fuel common rails 21 and 22.

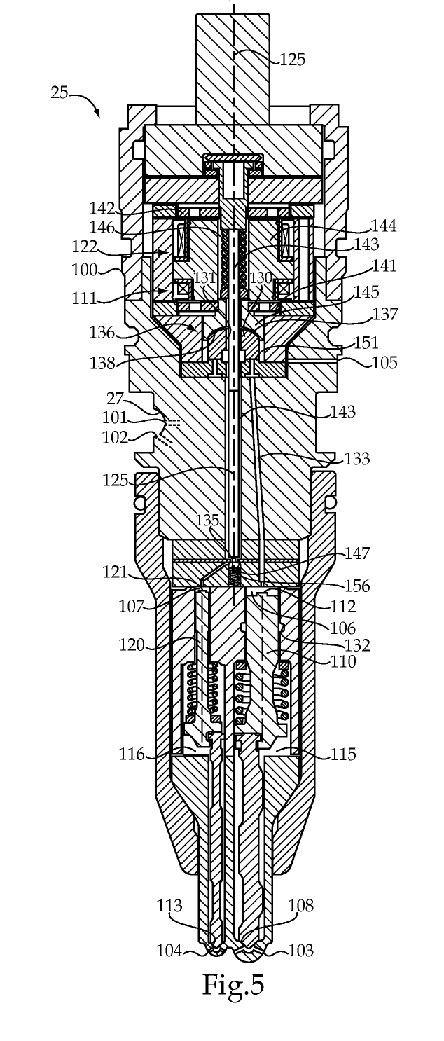

Referring also now to FIG. 5, a fuel injector 25 according to the present disclosure includes an injector body 100 positioned at least partially within one of cylinders 12 and having formed therein a gaseous fuel nozzle outlet or outlet set 103, a separate liquid fuel nozzle outlet or outlet set 104, and a drain outlet 105. Injector body 100 also defines first fuel inlet 101 and second fuel inlet 102 opening through a common conical seat 27 of fuel injector 25, and providing fluid communication between common rails 21 and 22 and outlet sets 103 and 104, respectively. Disposed within injector body 100 are a first control chamber 106 and a second control chamber 107. A first check valve member or gaseous fuel outlet check 110 has a closing hydraulic surface 112 exposed to fluid pressure in first control chamber 106. First check valve member 110 is movable between a closed position, as shown, in contact with a first seat 108 to fluidly block fuel inlet 101 from nozzle outlet set 103, and an open position out of contact with first seat 108 to fluidly connect fuel inlet 101 to nozzle outlet set 103 via a gaseous fuel passage shown partially and in dashed lines in the sectioned view of FIG. 5. A second check valve member or liquid fuel outlet check 120 has a closing hydraulic surface 121 exposed to fluid pressure in second control chamber 107. Second check valve member 120 is movable between a closed position, as shown, in contact with a second seat 113 to fluidly block fuel inlet 102 from nozzle outlet set 104, and an open position out of contact with second seat 113 to fluidly connect fuel inlet 102 to nozzle outlet set 104 via a liquid fuel passage shown partially and in dashed lines in the sectioned view of FIG. 5. Thus, injection of a first fuel (e.g., natural gas) through nozzle outlet set 103 is facilitated by movement of check valve member 110, while injection of a second fuel (e.g., liquid diesel) through nozzle outlet set 104 is facilitated by movement of check valve member 120. Those skilled in the art will appreciate that nozzle outlet sets 103 and 104 might be expected to each include six nozzle outlets that are arranged around respective centerlines in a manner well known in the art. However, nozzle outlet sets 103 and 104 could each include as few as one nozzle outlet or any number of nozzle outlets in any arrangement without departing from the scope of the present disclosure. In still other embodiments, rather than side-by-side outlet checks, dual concentric check fuel injectors might be used.

A first control valve member 130 is positioned in injector body 100 and is movable along a common centerline 125 between a first position in contact with a flat seat 151 at which control chamber 106 is fluidly blocked from drain outlet 105, and a second position at which control chamber 106 is fluidly connected to drain outlet 105 via a control passage 133. When control chamber 106 is fluidly connected to drain outlet 105, pressure in control chamber 106 drops, relieving pressure on closing hydraulic surface 112 to allow check valve member 110 to lift to facilitate an injection of the first fuel (e.g. natural gas) through nozzle outlet set 103. A second control valve member 135 is positioned in injector body 100 and movable along the common centerline 125 between a first position in contact with flat seat 156 at which control chamber 107 is fluidly blocked to drain outlet 105, and a second position out of contact with flat seat 156 at which control chamber 107 is fluidly connected to drain outlet 105. When control chamber 107 is fluidly connected to drain outlet 105, fluid pressure acting on closing hydraulic surface 121 is relieved to allow check valve member 120 to lift to an open position to facilitate injection of the second fuel (e.g. liquid diesel) through nozzle outlet set 104. Return of closing hydraulic pressure in control chambers 106 and 107 enables check valve members 110 and 120 to close.

In the illustrated embodiment, control valve member 135 is intersected by common centerline 125, but control valve member 130 defines a bore 131 therethrough that is concentric with common centerline 125. The respective control valve members 130, 135 may be moved to one of their respective first and second positions with first and second electrical actuators 111, 122, respectively. Control valve members 130, 135 may be biased to the other of their respective first and second positions by a spring(s) 146, 147. In particular, a first armature 141 may be attached to a pusher 145 in contact with control valve member 130. Armature 141, pusher 145 and control valve member 130 may be biased to the position shown, in contact with flat seat 151, by biasing spring 146. Control valve member 130 may rotate slightly about an axis perpendicular to common centerline 125 through the action of a self-alignment feature 136 that allows a convex surface 137 to move on a concave bearing surface 138 each time control valve member 130 contacts flat seat 151. Thus, armature 141 can be thought of as being operably coupled to move control valve member 130, and a second armature 142 may be operably coupled to move control valve member 135 by way of a plurality of pushers 143. A common stator 144 separates armature 141 from armature 142.

Control valve member 130 is in contact and out of contact with flat seat 151 at the first position and the second position, respectively. Likewise, control valve member 135 is in contact and out of contact with flat seat 156 at its first position and second position, respectively. Either or both of seats 151 and 156 may instead be conical. Control valve member 130 may be coupled to move with armature 141 responsive to de-energizing a lower coil mounted in common stator 144. When the lower coil mounted in common stator 144 is energized, armature 141 and pusher 145 are lifted upward allowing the high pressure in control passage 133 to push control valve member 130 out of contact with flat seat 151 to fluidly connect control chamber 106 to drain outlet 105. Control chamber 106 and control chamber 107 may always be fluidly connected to fuel inlet 102 via passages not visible in the section view of FIG. 5. Thus, liquid diesel from fuel inlet 102 may be utilized as the control fluid to control the operation of check valve member 110 to facilitate gaseous fuel injection events and member 120 to facilitate liquid fuel injection events.

A hydraulic lock seal 132 in the form of an annulus always fluidly connected to fuel inlet 102 may be useful in inhibiting the migration of gaseous fuel from gaseous nozzle chamber 115 up into control chamber 106. Gaseous nozzle chamber 115 is always fluidly connected to fuel inlet 101 via passages not visible in FIG. 5, and typically also thus fluidly connected to common rail 21, providing fluid communication between outlet set 103 and common rail 21. When dual fuel system 20 is operating in a regular (gaseous fuel) mode, liquid fuel common rail 22 may be maintained at a medium high pressure (e.g., maybe 40 MPa), and gaseous fuel common rail 21 may be maintained at a medium low pressure (e.g., maybe 35 MPa). This slight pressure differential is intended to inhibit leakage of gaseous fuel into the liquid fuel portions of fuel injector 25 and hence the entire dual fuel system 20. The inclusion of hydraulic lock seal 132 is another feature to inhibit gaseous fuel from migrating into the liquid fuel side of dual fuel system 20. Nevertheless, one might expect some amount of leakage of liquid fuel into the gaseous fuel side of the system via a leak path formed past hydraulic lock seal 132 during regular mode of operation, but this small amount of leakage may be encouraged in order to facilitate proper lubrication of moving parts. For instance, a small amount of liquid diesel fuel may leak from hydraulic lock seal 132 down into gaseous nozzle chamber 115 during a regular mode of operation. One could expect this small amount of liquid diesel to be ejected from nozzle outlet set 103 with each gaseous injection event. This small amount of leaked liquid diesel may also serve to help lubricate the guiding movement of first check valve member 110 and the seat 108 during regular mode of operation.

Dual fuel system 20 may also have a single fuel or liquid only mode of operation in which only liquid diesel fuel is utilized to power engine system 10. This mode of operation may be a “limp home” mode, and may only be preferable when there is some fault in the gaseous fuel system. In accordance with the present disclosure, a fault may include a malfunction of one or more of gas supply pressure and control mechanisms 16, a leak, a malfunction elsewhere in dual fuel system 20, or may simply relate to a lack of sufficient gaseous fuel to continue operating in the regular mode. Other liquid only modes may include a cold start operating mode, or a start after service mode, each representing a case where operation solely with liquid fuel is desirable or necessary. When operating in a liquid only mode, electronic control unit 15 may maintain common rail 22 at a high pressure (e.g., maybe 80 MPa), whereas the pressure in gaseous fuel common rail 21 may be allowed to decay. Between or among the various operating modes common rail 22 will typically be maintained at or adjusted among a range of higher pressures, relative to a medium pressure or range of medium pressures for common rail 21. During the liquid only mode, engine 10 may be operated as a conventional diesel engine in which liquid diesel fuel is injected through nozzle outlet set 104 in sufficient quantities and at timings to compression ignite. On the other hand, during the regular mode of operation, one might expect a relatively small pilot diesel liquid injection through nozzle outlet set 104 to be compression ignited to in turn ignite a much larger charge of gaseous fuel injected through nozzle outlet set 103 to power engine system 10. Transitioning from normal to liquid only operation will thus typically entail commanding increasing pressure in common rail 22 via pump 52 to accommodate increased liquid fueling demands, and commanding shutting shut off valve 46.

### INDUSTRIAL APPLICABILITY

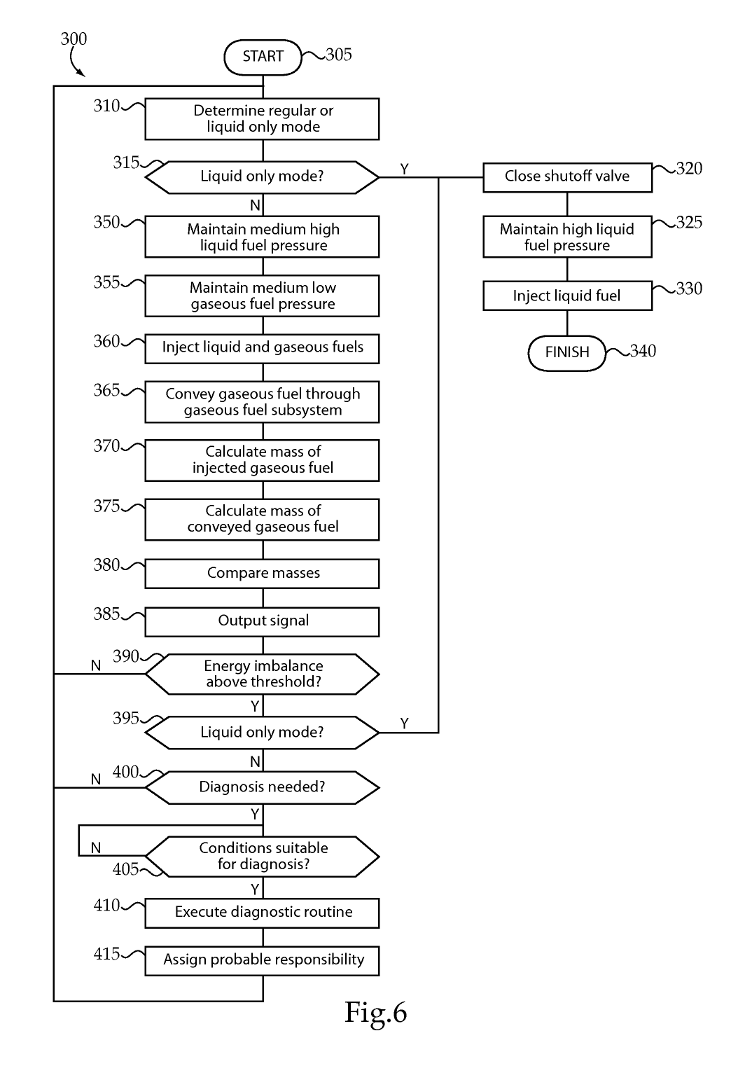

Referring now in particular to FIG. 6, but also with reference to features of the present disclosure shown in other Figures, there is shown a flowchart 300 illustrating example control logic executed by electronic control unit 15, according to the present disclosure. The process/logic of flowchart 300 starts at step 305, and proceeds to step 310 at which electronic control unit 15 may determine regular or liquid-only mode. As discussed above, a variety of instances may exist where liquid-only mode is desirable or necessary. It will generally be desirable to operate engine system 10 in regular mode injecting both gaseous fuel and liquid fuel directly into cylinders 12 via outlet sets 103 and 104 of fuel injectors 25, and compression igniting the injected liquid fuel to ignite the injected gaseous fuel, a majority of the time that engine system 10 is operating. From step 310, the process may advance to step 315 to query whether liquid-only mode is to occur. If yes, the process may advance to step 320 at which electronic control unit 15 may command shutting off supply of gaseous fuel, such as via commanding closing shutoff valve 46 or allowing shutoff valve 46 to close. In the case that liquid-only mode is already in place, no action need be taken at step 320.

From step 320, or potentially in parallel, the process may advance to step 325 at which electronic control unit 15 may maintain a high liquid fuel pressure. In the case of engine system 10 transitioning from regular mode to liquid-only mode, it will typically be desirable to increase liquid fuel pressure in liquid fuel common rail 22, in which case at step 325 electronic control unit 15 will be understood to command increasing a fuel pressure in common rail 22 such as via commanding a suitable change in operation or configuration of pump 52. Where engine system 10 is not transitioning from a regular mode to a liquid-only mode, but is instead continuing operation in liquid-only mode, at step 325 electronic control unit 15 can merely maintain the state or configuration of pump 52. From step 325, the process may advance to step 330 to inject liquid fuel, such as via determining and outputting suitable liquid fuel injection control signals for fuel injectors 25. It will be appreciated that liquid fuel injection amounts in liquid-only mode will typically be relatively greater than liquid fuel injection amounts in regular mode. The process may then finish at step 340, or could instead loop back to repeat the procedure beginning at steps 310 or 315.

If, at step 315, liquid-only mode is not to occur, the process may advance to step 350 where electronic control unit 15 can maintain a medium high liquid fuel pressure via suitable control of pump 52. It will also be understood by those skilled in the art that liquid fuel common rail 22 would likely be equipped with a pressure sensor to enable closed loop control of liquid fuel pressure in common rail 22 via pump 52 and feedback from that rail pressure sensor. From step 350, the process may advance to step 355 at which electronic control unit 15 can maintain a medium low gaseous fuel pressure in gaseous fuel common rail 21, potentially also via closed loop control of mechanisms 16 responsive to feedback from sensor 24. From step 355, the process may advance to step 360 at which electronic control unit 15 commands injection of liquid and gaseous fuels into each cylinder 12, and as discussed herein via outlet sets 103 and 104 in the same fuel injector.

It will be readily understood that injection of gaseous and liquid fuels consumes those fuels from their respective common rails 21 and 22. For this reason, mechanisms 17 will typically respond to the depletion of liquid fuel via supplying liquid fuel to common rail 22 to maintain the pressurized supply therein. Likewise, mechanisms 16 will typically be controlled via electronic control unit 15 to convey gaseous fuel through gaseous fuel subsystem 23 to compensate for depletion of gaseous fuel via the injection thereof. In the case of gaseous fuel subsystem 16, injection of gaseous fuel will tend to result in a drop in a pressure of gaseous fuel in accumulator 44 as common rail 21 is re-supplied via fueling control module 45. Electronic control unit 15 will typically be tasked with maintaining a gaseous fuel pressure in accumulator 44 within a predefined range. Once gaseous fuel pressure in accumulator 44 drops below the range, electronic control unit 15 may command pump 49 to turn on, or increase its pumping rate or displacement, to restore gaseous fuel pressure in accumulator 44 responsive to a sensed accumulator pressure as indicated via sensor 48. While accumulator 44 is being charged via the conveying of gaseous fuel, injection of gaseous fuel into cylinders 12 may continue, thus gaseous fuel pressure in accumulator 44 can be dependent upon both the output flow from pump 41, and the withdrawal of gaseous fuel from subsystem 23 to accommodate engine fueling demands.

From step 360, the process may advance to step 365 to convey gaseous fuel through gaseous fuel subsystem 23 in this general manner. From step 365, the process may advance to step 370 to calculate a mass of injected gaseous fuel, and then to step 375 to calculate a mass of the conveyed gaseous fuel. Those skilled in the art will appreciate that a mass of gaseous fuel corresponds to its energy content available for combustion, at least theoretically. Energy content of natural gas, for example, varies relatively widely across the globe. Thus, energy content of gas obtained at one location may be different than energy content of gas obtained at another location. The present disclosure is concerned with relative differences in energy contents, however, and thus some variability in absolute energy content from location to location will not affect the capacity for detection of energy imbalances. It should further be noted it can be assumed that all gaseous fuel is combusted, even though of course some relatively small amount can be passed through the engine with burning. Accordingly, during or prior to steps 370 and 375, electronic control unit 15 is receiving data indicative of an energy content of the injected gaseous fuel, and data indicative of an energy content of the conveyed gaseous fuel. From step 375, the process may advance to step 380 to compare the calculated masses, and thenceforth to step 385 to output a signal indicative of an energy imbalance between the injected gaseous fuel and the conveyed gaseous fuel responsive to the data indicative of the respective energy contents. Another way to understand the logic at step 385 is that electronic control unit 15 may be performing calculations, on a data processor, and the result of the calculations being output internally or externally in the form of an electrical signal indicative of an imbalance in the energy contents. The signal may be indicative that an energy imbalance exists, and also indicative of a magnitude of the energy imbalance.

From step 385, the process may advance to step 390 to query whether the energy imbalance is above a threshold. Since some inherent energy imbalance even in a system functioning at its highest practicably attainable efficiency can often be expected, as well as measurement errors, a predefined threshold may be established with which the energy imbalance is compared to determine whether and what action needs to be taken. If, at step 390, the energy imbalance is not above the threshold, the process may loop back to execute step 310 again or might simply exit. If, at step 390, the energy imbalance is above the threshold, the process may advance to step 395 to query whether liquid only mode is to be executed. The signal outputted in step 385 may be indicative of a magnitude of the energy imbalance. If the energy imbalance is of a relatively large magnitude, this could be taken as an indication that a failure in gaseous fuel subsystem 23 has occurred or is likely to occur. Likewise, a relatively large magnitude energy imbalance could also be indicative of power output of engine system 10 in regular mode being limited, or a desired power output only available at a high level of inefficiency. In any case, a relatively large magnitude energy imbalance may justify operation in liquid-only mode, in which case the process may advance from step 395 to step 320. In parallel, electronic control unit 15 may log a fault and notify the operator via alert 13 of the problem and/or that only reduced engine power is available. Analogously a site manager might be notified via a signal from transmitter/receiver 36.

As noted above, a relatively minor magnitude of energy imbalance may not justify taking any action, other than perhaps storing the data for future reference. In the case of the energy imbalance being of moderate magnitude, liquid-only mode may not be deemed necessary, but it may be undesirable to ignore the energy imbalance. In other words, a moderate energy imbalance may be indicative of a problem, but one that is not yet severe enough to justify limping home in liquid-only mode. In such case, the process may advance from step 395 to step 400 to query whether a diagnosis is needed. At step 400, electronic control unit 15 may be understood as evaluating whether the magnitude of an energy imbalance above the threshold as determined at step 390 is such that a diagnosis of the operational problem is necessary or desired, or for instance whether the fact that a problem has been detected should merely be logged as a fault for further or future reference. In the latter case, electronic control unit 15 might log a fault on computer readable memory 47, and the process could loop back to execute step 310 again, or could exit. If instead a diagnosis is considered necessary or desirable, the process may advance to step 405 to query whether conditions are suitable for diagnosis. If no, step 405 might be repeated until suitability conditions are detected. If yes, the process may advance to step 410 to execute a diagnostic routine, for instance electronic control unit 15 executing a stored diagnostic algorithm on memory 47. From step 410, the process may advance to step 415 to assign probable responsibility for the energy imbalance, via the execution of the diagnostic algorithm. From step 415, the process may loop back to execute step 310 again, or could exit.

As noted above, detecting an energy imbalance in fuel system 20 may include comparing a mass of injected gaseous fuel with a mass of gaseous fuel being conveyed through subsystem 23 to compensate for depletion of gaseous fuel via its injection. In one practical implementation strategy, gaseous fuel masses in and out of accumulator 44 are summed and compared to actual engine usage, in a time step. The actual engine usage can be determined or inferred from engine fueling rates determinable via stored engine fueling maps, and also gaseous rail pressure. The engine fueling maps will typically determine an injection on-time, and thus considered with gaseous rail pressure can readily enable a gaseous fuel mass to be determined. The gaseous fuel mass into the accumulator can be determined on the basis of a pressure rise in accumulator 44, as indicated via data from sensor 48, in a time step. Since a volume of accumulator 44 is known or can be readily determined, time integration of a pressure rise in the known volume in a time step enables determination of the mass of gaseous fuel fed into accumulator 44 according to known physical principles. The time step will typically be of sufficient duration to capture at least two pumping strokes of pump 49. It will be recalled that fueling control module 45 can meter the gaseous fuel conveyed from accumulator 44 to gaseous fuel common rail 21. Accordingly, the mass of gaseous fuel exiting accumulator 44 to be injected into cylinders 12 will be dependent at least in part upon the rate at which gaseous fuel passes through module 45. This fueling rate can be time integrated in the same time step for which gaseous fuel mass into accumulator 44 is calculated, to determine gaseous fuel volume out of accumulator 44. From the determined volume, a pressure of the gaseous fuel may be used to calculate, according to known physical principles, gaseous fuel mass.

Determining the existence of an energy imbalance such as by way of comparing the gaseous fuel masses as described herein can serve as an indication that an operational problem in engine system 10 exists. Once an energy imbalance is detected, the probable cause of the energy imbalance can be diagnosed at least in certain instances by way of executing a diagnostic routine as mentioned above. In one practical implementation strategy, once it has been determined that diagnosis is needed, electronic control unit may monitor engine operating conditions such as engine load to determine when conditions are suitable for diagnosis, or induce such conditions, and can then perform tests to gather additional data as to energy imbalance and isolate its cause to a certain component or part of fuel system 20.

At relatively lower engine load, such as an idle state, gaseous fuel mass out of the accumulator will tend to be relatively small, in which case the pressure and mass of gaseous fuel in accumulator 44 may be dependent primarily on behavior of pump 49. It can be determined that an energy imbalance detected during such conditions is likely due to an operational problem with pump 49 such as a leak within pump 49, running low on fuel in supply 40, or leaks or breaks elsewhere in gaseous fuel subsystem 23 upstream from fuel injectors 25. Data gathered through diagnostic operation at idle may also indicate pump performance in terms of efficiency, and can thus serve as a prognostic for future pump performance, particularly when used to populate a stored history of analogously gathered data. In one practical implementation, electronic control unit 15 may assign probable responsibility to pump 49 responsive to detection of an energy imbalance, typically above a threshold, and where an indicated engine load is lower. Assigning probable responsibility could include storing an error code on memory 47, for example.

At higher engine loads, pressure and mass of gaseous fuel in accumulator 44 will tend to be predominantly dependent upon behavior of fuel injectors 25. Stuck injectors, coked or otherwise plugged injectors, failed actuators, or any of a variety of other injector problems can result in an energy imbalance attributable to one or more of fuel injectors 25. Both present and imminent fuel injector failures can be detected in this manner, as well as a prognosis for future fuel injector performance. For example, it might be discovered that fuel injector performance is steadily degrading, suggesting progressive coking and the need for servicing prior to a next scheduled service interval. Electronic control unit 15 may thus assign probable responsibility to fuel injectors 25 responsive to detection of an energy imbalance, typically above a threshold, where an indicated engine load is higher. In the case of both idle and higher load testing, electronic control unit 15 could wait for suitable conditions to occur, or it could induce them. It is contemplated that electronic control unit 15 might monitor operation of machine 4 and detect when machine 4 is parked, for instance, and then controllably operate engine system 10 at idle and then at high load, gathering data under each condition. Testing at higher loads might occur subsequent to testing at idle to provide a ready point of comparison once engine load is increased and fuel system 20 transitions from a state where pressure and mass of gaseous fuel in accumulator 44 are less dependent upon fuel injector behavior to a state where the pressure and mass are more dependent upon fuel injector behavior.

In view of the foregoing, it will be appreciated that electronic control unit 15 may be thought of as initially detecting an energy imbalance, then taking further steps based upon the magnitude or severity of the energy imbalance to diagnose the probable cause. In some instances, an energy imbalance may be great enough to conclude that a failure in gaseous fuel subsystem 23 has occurred or is imminent, and liquid-only mode should be initiated. In other instances an energy imbalance may be so minor that no action need be taken at all. In still other instances, the energy imbalance may be such that diagnosis is considered advantageous, to identify the probable cause and/or determine whether servicing is needed prior to the next scheduled service interval. In all cases, electronic control unit 15 may store data relating to detected energy imbalance to enable analysis of trends and predictions of future performance.

Another diagnostic strategy might include monitoring pumping duration of pump 49, detecting when a duration for a full pump stroke is less than a target duration or greater than a target duration, or less than/greater than a duration at an earlier time. In the case of the detected duration being higher than target, it might be concluded that pump 49 is leaking. In the case of detected duration being less than target, it might be concluded that pump friction is high. Still another diagnostic strategy might include monitoring accumulator pressure fall rate when pump 49 is not pumping and comparing it with engine requested fueling. If engine usage rate, i.e. mass, is lower than requested it might be concluded that injection is not occurring in one or more cylinders, or that injector nozzles are likely coked or otherwise plugged. If engine usage rate is higher than requested sticky injectors or a gas line or fuel control module leak may be responsible. As with the foregoing diagnostic strategies, both monitoring of pumping duration and monitoring accumulator pressure fall rate can yield data useful in detection of adverse system health on the basis of energy imbalance, and data useful in predicting future performance or trends. Moreover, the general principles set forth herein relating to detection of energy imbalance, and acting upon such detection, can also be expected to find application in components and parts of gaseous fuel subsystems other than those specifically discussed herein.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of operating a dual gaseous and liquid fuel engine system comprising the steps of:
injecting gaseous fuel and liquid fuel directly into an engine cylinder via a gaseous fuel outlet set and a liquid fuel outlet set, respectively, of at least one fuel injector in the engine system;
compression igniting the injected liquid fuel to ignite the injected gaseous fuel;
conveying gaseous fuel through a gaseous fuel subsystem in the engine system to compensate for depletion of gaseous fuel via the injection thereof;
receiving data indicative of an energy content of the injected gaseous fuel;
receiving data indicative of an energy content of the conveyed gaseous fuel; and
outputting a signal indicative of an energy imbalance between the injected gaseous fuel and the conveyed gaseous fuel responsive to the data indicative of the respective energy contents.

2. The method of claim 1 wherein each of the steps of receiving includes receiving data indicative of gaseous fuel mass.

3. The method of claim 2 further comprising a step of comparing a mass of the injected gaseous fuel with a mass of the conveyed gaseous fuel, and wherein the step of outputting includes outputting a signal responsive to a difference between the masses.

4. The method of claim 3 wherein the signal is indicative of a magnitude of the energy imbalance.

5. The method of claim 4 further comprising a step of commanding shutting off a supply of the gaseous fuel and increasing a fuel pressure in a liquid fuel common rail supplying liquid fuel to a plurality of fuel injectors in the engine system for operation in a liquid fuel only mode, responsive to the signal.

6. The method of claim 3 wherein the step of conveying further includes charging a gaseous fuel accumulator positioned fluidly between a cryogenic pump and a gaseous fuel common rail supplying gaseous fuel to a plurality of fuel injectors in the engine system.

7. The method of claim 6 wherein the step of injecting includes injecting both the gaseous fuel and the liquid fuel via the same fuel injector.

8. The method of claim 6 further comprising the steps of calculating the mass of the conveyed gaseous fuel on the basis of a mass of gaseous fuel charging the accumulator in a time step, and calculating the mass of the injected gaseous fuel on the basis of an engine fueling rate in the time step.

9. The method of claim 2 further comprising the steps of executing a diagnostic algorithm responsive to the signal, and assigning probable responsibility for the energy imbalance via the execution of the diagnostic algorithm.

10. The method of claim 9 further comprising the steps of receiving data indicative of engine load, and receiving data indicative of a pressure rise in the accumulator, and wherein the step of assigning occurs responsive to the data indicative of engine load and the data indicative of a pressure rise.

11. The method of claim 10 wherein the step of assigning further includes assigning probable responsibility for the imbalance to the plurality of fuel injectors where indicated engine load is higher, and to a cryogenic pump where indicated engine load is lower.

12. A dual gaseous and liquid fuel engine system comprising:
an internal combustion engine including a plurality of cylinders formed in an engine housing;
a gaseous fuel subsystem including a gaseous fuel common rail, and gaseous fuel supply and pressure control mechanisms configured to convey a gaseous fuel through the gaseous fuel subsystem to supply the gaseous fuel common rail;
a liquid fuel subsystem including a liquid fuel common rail, and liquid fuel supply and pressure control mechanisms configured to convey a liquid fuel through the liquid fuel subsystem to supply the liquid fuel common rail;
a plurality of fuel injectors each including a fuel injector body positioned at least partially within one of the plurality of cylinders and having formed therein a gaseous fuel outlet set in fluid communication with the gaseous fuel common rail, for injecting a gaseous fuel into the one of the plurality of cylinders, and a liquid fuel outlet set in fluid communication with the liquid fuel common rail, for injecting a liquid fuel into the one of the plurality of cylinders; and
a control system including an electronic control unit configured to receive data indicative of an energy content of injected gaseous fuel and data indicative of an energy content of gaseous fuel conveyed through the gaseous fuel subsystem to compensate for depletion of gaseous fuel via injection thereof, and being further configured to output a signal indicative of an energy imbalance between the injected gaseous fuel and the conveyed gaseous fuel, responsive to the data indicative of the respective energy contents.

13. The engine system of claim 12 wherein the electronic control unit is further configured to calculate a mass of the injected gaseous fuel and a mass of the conveyed gaseous fuel, and to output the signal responsive to a difference between the calculated masses.

14. The engine system of claim 13 wherein the electronic control unit is further configured to calculate the mass of the conveyed gaseous fuel on the basis of a mass of gaseous fuel charging an accumulator in the gaseous fuel subsystem in a time step, and to calculate the mass of the injected gaseous fuel on the basis of an engine fueling rate in the time step.

15. The engine system of claim 14 further comprising a computer readable memory storing a diagnostic algorithm, and wherein the electronic control unit is further configured to execute the diagnostic algorithm responsive to the signal, and to assign probable responsibility for the energy imbalance via the execution of the diagnostic algorithm.

16. The engine system of claim 15 wherein the gaseous fuel supply and pressure control mechanisms include a pressure sensing mechanism configured to sense a fluid pressure in the accumulator, and wherein the electronic control unit is further configured to receive data indicative of engine load, and data indicative of a pressure rise in the accumulator from the pressure sensing mechanism, and to assign probable responsibility for the energy imbalance responsive to the data indicative of engine load and data indicative of the pressure rise.

17. The engine system of claim 12 wherein:
the gaseous fuel supply and pressure control mechanisms include a gaseous fuel shutoff valve, and the liquid fuel supply and pressure control mechanisms include a pump configured to pressurize the liquid fuel supplied to the liquid fuel common rail; and
the electronic control unit is further configured to command closing the gaseous fuel shutoff valve and increasing pressurization of the liquid fuel via the pump for operation of the engine system in a liquid only mode, responsive to the signal.

18. A method of detecting adverse system health in a dual gaseous and liquid fuel engine system comprising the steps of:
receiving data indicative of an energy content of gaseous fuel injected via a fuel injector into a cylinder of an internal combustion engine and ignited therein via compression ignition of a liquid fuel injected via the same fuel injector;
receiving data indicative of an energy content of gaseous fuel conveyed through a gaseous fuel conduit in the engine system to compensate for depletion of gaseous fuel via the injection thereof; and
logging a fault responsive to an energy imbalance between the injected gaseous fuel and the conveyed gaseous fuel indicated by the data indicative of the respective energy contents.

19. The method of claim 18 wherein the data indicative of energy contents includes data indicative of gaseous fuel mass.
